(19) United States
(12) Patent Application Publication
(10) Pub. No.: US 2007/0058653 A1
(43) Pub. Date: Mar. 15, 2007

(54) Method and apparatus for efficient assigning of addresses for a mobile station

(76) Inventors: John M. Harris, Chicago, IL (US); Ronald T. Crocker, St. Charles, IL (US)

Correspondence Address: MOTOROLA, INC., 1303 EAST ALGONQUIN ROAD, IL01/3RD, SCHAUMBURG, IL, 60196, US

(21) Appl. No.: 11/225,237

(22) Filed: Sep. 13, 2005

(51) Int. Cl. H04J 3/26

(52) U.S. Cl. 370/432

(57) ABSTRACT

A method and apparatus is provided to efficiently assign addresses for a mobile station (110) that monitors one or more broadcast groups. The mobile station (110) determines (210) at least one broadcast group to monitor. A broadcast server (150) determines (220) the broadcast time for the monitored broadcasts group(s). A broadcast server (150), mobile switching center (130), or mobile station (110) then determines (230) an address for the mobile station (110) that minimizes the wake up times for the mobile station for monitoring the chosen broadcast group. Preferably, the address is assigned a wake up time corresponding to a broadcast time for a monitored broadcast group. Further, a second preferred address may be determined (450) that is assigned to a second broadcast group. The mobile station (110) is registered (430) under the chosen address(es) if the mobile station (110) is not already assigned to one of the chosen addresses.

### TECHNICAL FIELD

This invention relates to wireless communication systems and more particularly to wireless communication systems where a mobile station monitors multiple addresses for receiving data.

### BACKGROUND

Wireless communication systems are known in the art wherein a mobile station, such as a mobile phone, wirelessly networked work station, or other mobile device monitors multiple channels or addresses when receiving data. To conserve battery power, however, a mobile station will typically enter into a standby mode to conserve battery power when not in active communication with a transceiver. The mobile station, then, must power up at certain known intervals to monitor whether data is available to download from a given address. The times at which the mobile station senses for data are often called wake up times.

Should a user of a mobile station wish to monitor multiple sources of data, the mobile station will typically need to wake up multiple times in a given cycle to monitor those sources. For example, a mobile station can be assigned a number of addresses wherein each address has a particular data type to download and a designated time or slot at which the data is available for monitoring. For instance, a single mobile station can be assigned a private address to monitor for data only intended for that mobile station such as a voice call to the mobile station. In addition, the mobile station user may wish to monitor other group addresses. The group addresses carry data from a server that is broadcast to a plurality of mobile stations such as a group voice call or data from a subscription information service where users subscribe to receive information sent periodically to the user's mobile station.

When a user wishes to monitor a plurality of addresses, the mobile station must usually wake up for each designated broadcast time for each monitored address. Waking up in this fashion, however, causes a potentially significant drain on the battery. A further disadvantage is that the mobile station may experience a delay in receiving broadcast data if the mobile station does not wake up for every broadcast time.

### BRIEF DESCRIPTION OF THE DRAWINGS

The above needs are at least partially met through provision of the method and apparatus for efficient assigning of addresses for a mobile station described in the following detailed description, particularly when studied in conjunction with the drawings, wherein:

FIG. 1 is a block diagram as configured in accordance with various embodiments of the invention;

FIG. 2 is a flow diagram depicting a method as configured in accordance with various embodiments of the invention;

FIG. 3 is a flow diagram depicting an alternative to the method of FIG. 2;

FIG. 4 is a flow diagram depicting an alternative to the method of FIG. 2; and

FIG. 5 is a flow diagram depicting a method as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a method and apparatus are provided for determining at least one broadcast group to monitor via a mobile station, determining the broadcast time for the broadcast group(s), and determining an address for the mobile station that minimizes the wake up times for the mobile station when monitoring the broadcast group(s). Alternatively, the address may be tailored to fit within one or more conditions of the wireless communication system to optimize the efficiency of the system and/or better manage the resources of the mobile stations. Further, multiple addresses may be assigned to a mobile station to further enhance the efficiency of monitoring multiple broadcast groups.

By determining an address that at least largely minimizes the number of wake up times to be observed by the mobile station for a given delay performance requirement/requirements, the mobile station's battery life may be increased significantly. For example, if a mobile station's user wishes to monitor one broadcast group with an associated wake up time in each cycle in addition to the mobile station's private address, assigning the private address to match the wake up times of the broadcast group will cut in half the number of times the mobile station must wake up in each cycle to monitor for incoming data. This will often result in significantly increasing the standby battery life of the mobile station.

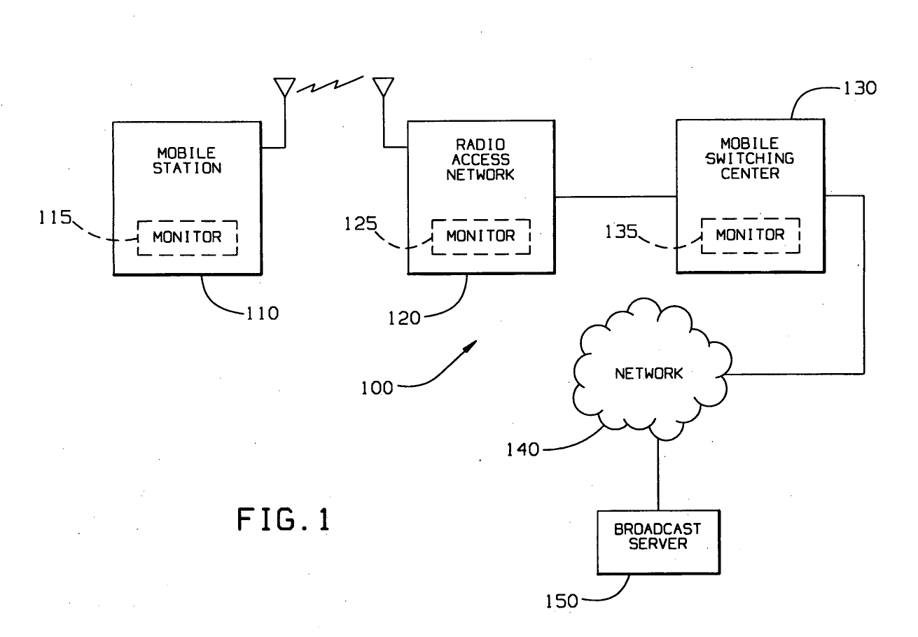

Referring now to the drawings, and in particular to FIG. 1, a wireless communication system 100 includes a mobile station 110, which may also include a monitor 115. The mobile station 110 is in wireless communication with a radio access network 120. As known in the art, a radio access network 120 can perform the radio functionality of a network including communicating wirelessly with a plurality of mobile stations 110. The radio access network 120 may include various types of structure depending on the method of communication used by the wireless communication system 100. For example, the radio access network 120 preferably includes a monitor 125. Further, the radio access network 120 may include a controller when operating in a 3GPP (“Third Generation Partnership Project”) compatible system, or the radio access network 120 may include a base transceiver station and/or a base station controller when operating in a 3GPP2 (“Third Generation Partnership Project 2”) compatible system.

The radio access network 120 is in communication with a mobile switching center 130. As is known in the art, the mobile switching center 130 may also include various structures to perform the function of connecting between the network 140 and the radio access network 120 and preferably includes a monitor 135. The mobile switching center 130 alternatively may be substituted for or include a home location register and/or a visitor location register. The home location register and visitor location register, as known in the art, perform the function of registering addresses for the mobile stations 110 within a given area. Thus, as data is received from the network 140, the mobile switching center 130 and radio access network 120 can correctly route the data to a particular mobile station 110 given that mobile station's 110 address.

A broadcast server 150 is also in communication with the network 140. The network 140 may be any system through which data may be sent, such as the Internet. The broadcast server 150 broadcasts information that is received by mobile stations 110 in communication with the network 140. The broadcast server 150 can be any such server, such as a presence server, a push to talk server, a multimedia broadcast multicast service server, a broadcast and multicast server, or other such server. For example, a presence server, as known in the art, typically tracks a user's status, availability, or likelihood of accepting a call, e.g. as may occur also within a chat room or instant messaging group, and sends data to the participating users when necessary. A push to talk (“PTT”) server generally supervises the PTT application service that mobile stations intended to be contacted through a one touch service, and the PTT server then sends data to those mobile stations. A multimedia broadcast multicast service server, as known in the art, typically broadcasts multimedia data to subscribers' mobile stations 110. Examples of such data include picture or sound data relating to subscribers' interests. Similarly, a broadcast and multicast server will broadcast data to subscribers' mobile stations 110. Examples of such data include stock or sports data such that a subscriber may receive data updates in near real time. Each of the above or similar servers that provide data to mobile stations over the network 140 will typically have a specific broadcast schedule for the mobile station 110 to monitor.

One skilled in the art will recognize that the various individual circuits, monitors, servers, and other elements described herein, although when combined as described to form an embodiment of the invention, are readily designed and connected by one skilled in the art and may operate in conjunction with various software elements to perform according to this description. For example, the various servers are typically computers operating in conjunction with certain software elements. Additionally, the monitors are typically known or readily designed circuitry that together with various software elements can monitor the various factors as described herein. Other enabling structure can be applied by those skilled in the art as desired as well.

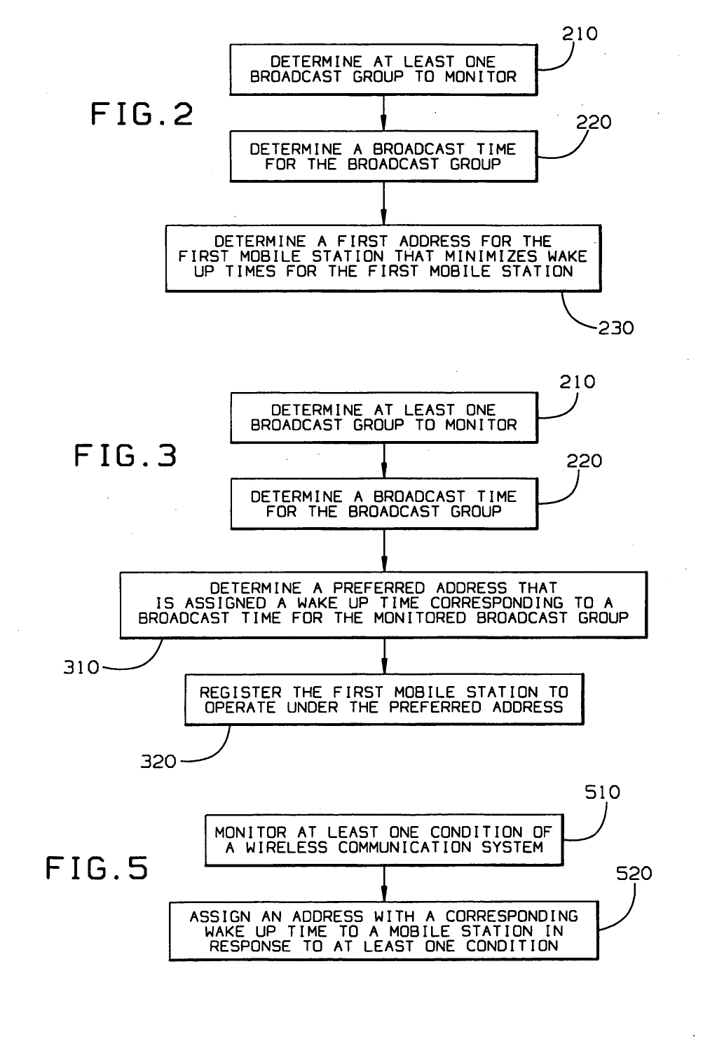

A method of operation of the above elements will be described with reference to FIG. 2. The mobile station 110 determines 210 at least one chosen broadcast group to monitor. To determine the chosen broadcast groups, the monitor 115 at the mobile station 110 monitors which of a plurality of broadcast groups are chosen by the user. Next, the broadcast server 150 determines 220 the broadcast time for each chosen broadcast group to be monitored by the mobile station 110. The broadcast time is typically calculated based on the private and broadcast addresses using a predetermined equation, and the broadcast server 150 will deliver the broadcast time to the mobile switching center 130, the radio access network 120, and the mobile station 110. The broadcast server 150, mobile switching center 130, or mobile station 110 then determines 230 an address for the mobile station 110 such that the address at least attempts to minimize wake up times for the mobile station for monitoring the chosen broadcast group. One skilled in the art will recognize that the invention may be applied using various address types such as, for example, a mac ID as used in certain protocols including the 802.16e protocol.

The structure that determines 230 an address for the mobile station 110 can be any of the broadcast server 150, mobile switching center 130, or mobile station 110. All that is required is processing circuitry, which each of the above structures typically includes, and associated software to apply the algorithm for choosing the appropriate address. Preferably, the mobile switching center 130 determines the address because the mobile switching center 130 will typically receive during its normal operation all the information necessary to make such a determination.

With reference to FIG. 3, after determining 210 the broadcast groups to monitor and determining 220 the broadcast times for the chosen broadcast groups, in a preferred embodiment, the broadcast server 150, mobile switching center 130, or mobile station 110 determines 310 a preferred address, from a plurality of address, that is assigned a wake up time corresponding to a broadcast time for at least one chosen broadcast group. Then, the mobile switching center 130 registers 320 the mobile station 110 to operate under the preferred address.

Preferably, the plurality of addresses are addresses previously assigned to the mobile station 110. For example, the previously assigned addresses may include IMSI (“International Mobile Subscriber Identity”) numbers assigned to the mobile station 110. As known in the art, IMSI numbers are unique identifier numbers allocated to each mobile subscriber in certain wireless communication networks. These numbers allow a mobile switching center 130 and radio access network 120 to distribute data to the correct mobile stations 110.

Alternatively, the plurality of addresses may include a plurality of TMSI (“Temporary Mobile Subscriber Identity”) numbers or UATI (“Unicast Access Terminal Identifier”) numbers. Both TMSI numbers and UATI numbers, as known in the art, are similar to IMSI numbers in that they allow the mobile switching center 130 and radio access network 120 to identify and/or maintain security for transferring data to mobile stations 110 within the mobile switching center's 130 zone. In such an embodiment, registering 320 the mobile station 110 to operate under the preferred address further includes assigning a TMSI number or a UATI number to the mobile station 110.

Preferably, when determining 310 the preferred address for the mobile station 110, the determined preferred address is assigned a wake up time that matches a broadcast time for at least one chosen broadcast group. In such an embodiment, by matching the preferred address to the chosen broadcast group, the extra wake up times to monitor the chosen broadcast group are eliminated or at least reduced, thereby conserving battery life. Further, the delay between the wake up time and broadcast time is reduced or eliminated thereby conserving battery life typically wasted in the delay. If the mobile station's user chooses to monitor multiple broadcast groups and designates one broadcast group as a preferred broadcast group, in a preferred embodiment, the broadcast server 150, mobile switching center 130, or mobile station 110 determines 310 a preferred address that is assigned a wake up time that matches a broadcast time for the preferred broadcast group. In this case, the mobile station 110 will be certain to receive updates from the preferred broadcast group.

As known in the art, different broadcast groups may broadcast data on different schedules. For example, one broadcast group may broadcast data once every cycle whereas another broadcast group may broadcast data once every five cycles. In this situation, it is preferable if the broadcast server 150, mobile switching center 130, or mobile station 110 determines 310 a preferred address that is assigned a wake up time that corresponds to a broadcast time for the broadcast group with a higher frequency of broadcasts. Thus, the mobile station 110 will be more reliably updated for the broadcast group that most often broadcasts data, and a greater (or even maximized) efficiency is achieved by matching up the wake up time with the most frequently broadcast group data.

In certain applications, the chosen broadcast groups will not all have broadcast times that match up with the preferred address. In such a situation, it is preferable that the broadcast server 150, mobile switching center 130, or mobile station 110 determines 310 a preferred address that is assigned a wake up time with a minimum (or at least reduced) delay between the wake up time and a broadcast time. Thus, the mobile station 110 minimizes wasted battery life by waiting for a minimal amount time for a broadcast group time that is not matched to the preferred address's wake up time.

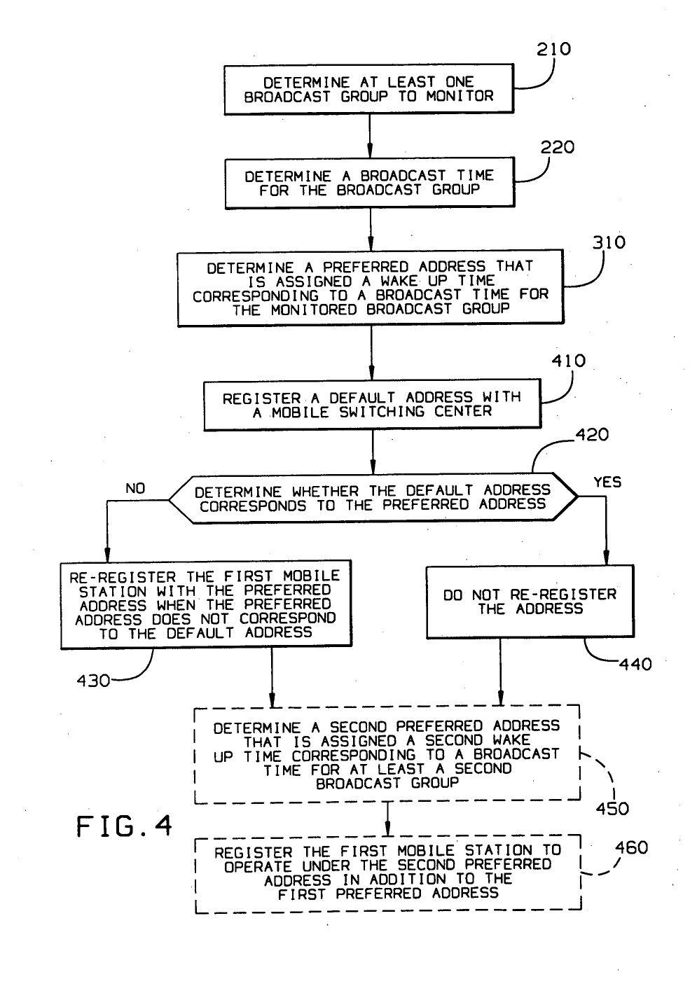

Another alternative embodiment will be described with reference to FIG. 4. Upon powering up a mobile station 110, the steps of determining 210 the broadcast groups to monitor, determining 220 the broadcast times for the chosen broadcast groups, and determining 310 the preferred address are performed as described above. In this embodiment, however, the mobile station 110 is registered 410 with a default address with the mobile switching center 130 in response to the powering up of the mobile station 110 as commonly performed by wireless communication systems. Then, the broadcast server 150, mobile switching center 130, or mobile station 110 determines 420 whether the default address corresponds to the preferred address. If the default address does not correspond to the preferred address, the broadcast server 150, mobile switching center 130, or mobile station 110 re-registers 430 the mobile station 110 with the preferred address. The re-registration 430 may occur immediately or during the next scheduled re-registration. If the default address does correspond to at least one preferred address, the address is not 440 re-registered. Alternatively, the default address may be a previously stored preferred address, in other words, an address previously used by the mobile station 110 as the preferred address. Using the previously stored preferred address may reduce the number of times the mobile station 110 needs to re-register 430 with the preferred address.

In a preferred embodiment and with continuing reference to FIG. 4, if the mobile station's 110 user has chosen at least a second broadcast group to monitor, the broadcast server 150, mobile switching center 130, or mobile station 110 determines 450 a second preferred address from the plurality of addresses that is assigned a second wake up time corresponding to the broadcast time for the second chosen broadcast group. Then, the mobile switching center 130 registers 460 the mobile station to operate under the second preferred address in addition to the first preferred address. This embodiment provides the mobile station 110 with the flexibility to have multiple wake up times to efficiently monitor at least two broadcast groups.

An additional aspect of certain embodiments of the invention will be described with reference to FIG. 5. One or more of the monitors 115, 125, and/or 135 monitor 510 at least one condition of the wireless communication system 100 within a zone. Then, the mobile switching center 130 assigns an address with a corresponding wake up time to a mobile station 110 within the zone at least partially in response to the monitored condition(s). The monitored conditions may be any one or more conditions reflecting on the operability of the wireless communication system 100.

In one embodiment, the monitor(s) 125 and/or 135 may monitor a percentage of mobile stations in the zone operating under each available wake up time. In such an embodiment, the mobile switching center 130 will assign an address with a wake up time at which a smaller percentage of mobile stations 110 operate when monitoring the percentage of mobile stations 110 in the zone operating in each of the available wake up times. In this manner, the wireless communication system 100 can spread the traffic load for a zone created by the broadcast groups across the available wake up times to avoid over stressing the system 100 during a given wake up time. An alternative to this embodiment includes the monitors 125 and/or 135 monitoring the number of mobile stations 110 in the zone operating under a single wake up time. In this embodiment the mobile switching center 130 can reassign wake up times when the number of mobile stations 110 operating under the single wake up time exceeds a predetermined number to avoid overly stressing the system 100.

In another alternative, monitors 125 and/or 135 will monitor the battery life of at least one mobile station 110 in the zone. In this case, the monitor 115 located in each mobile station 110 will monitor the battery life for that mobile station 110 and transmit a signal corresponding to the battery life to the radio access network 120 and/or mobile switching center 130 and their respective monitors 125 and 135, depending on which structure is configured to monitor the battery life. For example, a mobile switching center 130 will typically control a larger area than the radio access network 120, and thus, a larger zone may be controlled if the mobile switching center 130 monitors the battery life of the mobile stations 110. Otherwise, the radio access network 120 may monitor a smaller zone if that zone is most in need of oversight. Then, the mobile switching center 130 may assign an address with a preferred wake up time to mobile stations 110 within the zone with a reduced battery life when monitoring battery life of at least one mobile station 110 in the zone. Using this embodiment allows the wireless communication system 100 to assign the addresses with the preferred wake up times (i.e. the wake up times that provide the best efficiency) to the mobile stations 110 that most need that efficiency; i.e., those with a reduced battery life.

In yet another alternative, monitors 125 and/or 135 will monitor the priority level of at least one mobile station 110 in the zone. Then, the mobile switching center 130 may assign an address with a preferred wake up time to mobile stations 110 within the zone with a higher priority level when monitoring a priority level of at least one mobile station 110 in the zone. In this alternative, mobile station 110 users may subscribe to a service with a wireless communication system 100 operator for the provision of broadcast data, and the users may pay a premium to ensure that their mobile stations 110 are assigned a higher priority level and thus get assigned a preferred address with a preferred wake up time. Alternatively, certain mobile stations 110 used by higher priority users such as emergency response personnel may be assigned higher priority level. A mobile station's 110 priority level may be sent by the mobile station 110 upon powering up or upon entering a zone as part of its registration with the radio access network 120 and/or mobile switching center 130. As another approach the priority level associated with a given user platform may be stored in a database and correlated with another identifier used by that user platform such that the implementing network element can access that database and employ the user platform identifier to recover the priority level for the user platform.

In a further embodiment, monitors 125 and/or 135 monitor a traffic level within the zone and monitors 115, 125, and/or 135 monitor a mobility factor for at least one mobile station in the zone. Then, when determining that the mobility factor for the mobile station 110 is low and that the traffic level for the zone is small, the mobile switching center 130 assigns a private address to the mobile station 110. In this case, when a zone is experiencing low traffic levels and the mobile station 110 is not changing zones, it is less taxing on the wireless communication system's 100 resources to resend broadcast group data with the mobile station's 110 private address instead of only sending the broadcast group data on the group address times. Here, the mobile switching center 130 or radio access network 120 will receive the broadcast group data, broadcast that data with the group update time, and then resend that data to a subscribing mobile station 110 at that mobile station's 110 private address wake up time. The system 100 is able to handle this resending of data because the zone is not experiencing high traffic volumes and because the system need not re-register the mobile station 110 with new zones because of its low mobility factor.

One skilled in the art will recognize that any combination of the above factors may be monitored and used to determine the best addresses and wake up times to assign to any given mobile station. In this way, the total resources of the wireless communication system may be managed to increase the efficiency of the system and increase the effective battery life of the mobile stations operating within the system. Further, special priorities can be implemented to increase the efficiencies for certain priority mobile stations.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
determining at least one broadcast group to monitor via a first mobile station;
determining a broadcast time for the at least one chosen broadcast group;
determining a first address for the first mobile station such that the first address minimizes wake up times for the first mobile station for monitoring the at least one broadcast group.

2. The method of claim 1 wherein determining at least one broadcast group to monitor via the first mobile station further comprises monitoring at the first mobile station which of a plurality of broadcast groups are chosen by a user.

3. The method of claim 1 wherein determining a first address for the first mobile station further comprises:
determining a preferred address, from a plurality of addresses, that is assigned a wake up time corresponding to a broadcast time for the at least one broadcast group; and
registering the first mobile station to operate under the preferred address.

4. The method of claim 3 wherein the plurality of addresses comprises a plurality of addresses previously assigned to the first mobile station.

5. The method of claim 4 wherein the plurality of addresses previously assigned to the first mobile station further comprises International Mobile Subscriber Identity (“IMSI”) numbers assigned to the first mobile station.

6. The method of claim 3 wherein registering the first mobile station to operate under the preferred address further comprises:
the first mobile station registering a default address with a mobile switching center in response to powering up of the first mobile station;
determining whether the default address corresponds to the preferred address; and
re-registering the first mobile station with the preferred address when the preferred address does not correspond to the default address.

7. The method of claim 3 wherein registering the first mobile station to operate under the preferred address further comprises:
the first mobile station registering a previously stored preferred address with a mobile switching center in response to powering up of the first mobile station;
determining whether the previously stored preferred address corresponds to the preferred address; and
re-registering the first mobile station with the preferred address when the preferred address does not correspond to the previously stored preferred address.

8. The method of claim 3 wherein the plurality of addresses comprises a plurality of Temporary Mobile Subscriber Identity (“TMSI”) numbers and wherein registering the first mobile station to operate under the preferred address further comprises assigning a TMSI number to the first mobile station.

9. The method of claim 3 wherein the plurality of addresses comprises a plurality of Unicast Access Terminal Identifiers (“UATI”) numbers and wherein registering the first mobile station to operate under the preferred address further comprises assigning a UATI number to the first mobile station.

10. The method of claim 3 wherein determining the preferred address from the plurality of addresses that is assigned a wake up time corresponding to a broadcast time for the at least one broadcast group further comprises determining the preferred address that is assigned a wake up time that matches a broadcast time for the at least one broadcast group.

11. The method of claim 10 wherein determining the preferred address that is assigned a wake up time that matches a broadcast time for the at least one broadcast group further comprises determining the preferred address that is assigned a wake up time that matches a broadcast time for a preferred broadcast group.

12. The method of claim 3 wherein determining the preferred address from the plurality of addresses that is assigned a wake up time corresponding to a broadcast time for the at least one broadcast group further comprises determining the preferred address that is assigned a wake up time that corresponds to a broadcast time for a broadcast group with a higher frequency of broadcasts.

13. The method of claim 3 wherein determining the preferred address from the plurality of addresses that is assigned a wake up time corresponding to a broadcast time for the at least one broadcast group further comprises determining the preferred address that is assigned a wake up time with a minimum delay between a wake up time and a broadcast time.

14. The method of claim 3 further comprising:
determining a second preferred address from the plurality of addresses that is assigned a second wake up time corresponding to a broadcast time for at least a second broadcast group; and
registering the first mobile station to operate under the second preferred address in addition to the first preferred address.

15. A method comprising:
monitoring at least one condition of a wireless communication system within a zone;
assigning an address with a corresponding wake up time to a mobile station within the zone at least partially in response to the at least one condition.

16. The method of claim 15 wherein the at least one condition is any one from a group comprising:
a percentage of mobile stations in the zone operating under each available wake up time;
a traffic level within the zone;
a battery life of at least one mobile station in the zone;
a priority level of at least one mobile station in the zone;
a mobility factor for at least one mobile station in the zone; and
a number of mobile stations in the zone operating under a single wake up time.

17. The method of claim 15 wherein assigning an address with a corresponding wake up time to a mobile station within the zone at least partially in response to the at least one condition further comprises at least one of:
assigning an address with a wake up time at which a smaller percentage of mobile stations operate when monitoring a percentage of mobile stations in the zone operating under each available wake up time;
assigning an address with a preferred wake up time to mobile stations within the zone with a reduced battery life when monitoring battery life of at least one mobile station in the zone;
assigning an address with a preferred wake up time to mobile stations within the zone with a higher priority level when monitoring a priority level of at least one mobile station in the zone; and
assigning a private address to the mobile station when monitoring the mobility factor for the mobile station and determining that the mobility factor for the mobile station is small and that the traffic level within the zone is small.

18. An apparatus comprising:
means for determining at least one broadcast group to monitor via a first mobile station;
means for determining a broadcast time for the at least one chosen broadcast group;
means for determining a preferred address from a plurality of addresses that is assigned a wake up time corresponding to a broadcast time for the at least one broadcast group; and
means for registering the first mobile station to operate under the preferred address.

19. The apparatus of claim 18 wherein the means for determining a preferred address from a plurality of addresses that is assigned a wake up time corresponding to a broadcast time for the at least one broadcast group further comprises any one from a group comprising:
a mobile switching center;
a visitor location register;
a presence server;
a push to talk server;
a multimedia broadcast multicast service server;
a broadcast and multicast server; and
the first mobile station.
